(19) United States
(12) Patent Application Publication
(10) Pub. No.: US 2014/0209033 A1
(43) Pub. Date: Jul. 31, 2014

(54) Litter Wizard System

(71) Applicant: Katherine M. French, El Dorado Hills, CA (US)

(72) Inventor: Katherine M. French, El Dorado Hills, CA (US)

(21) Appl. No.: 13/754,832

(22) Filed: Jan. 30, 2013

(51) Int. Cl. A01K 1/01

(52) U.S. Cl. CPC A01K 1/0107
USPC 119/165; 435/198; 435/219

(57) ABSTRACT

The present invention consists of a two part system for controlling pet odor. The first part is an enzyme spray with a high concentration of microbes that consume ammonia. The second part of the system is absorbent granules that also contain the ammonia consuming microbes. When used in conjunction with each other, the system is ten times more effective at controlling pet odor than comparable one part systems. The microbes can penetrate into the cracks and crevices of most surfaces to further reduce the source of pet odors. The system also works to control moisture which allows for proper pet hygiene by reducing molds, fungus, insects, and parasite infestations. The system is a non-toxic and environmentally friendly product that will not harm pets if ingested. The system can be used with cat litter boxes, pet bedding, dog kennels, or any indoor area where pets expel their waste.

### RELATED APPLICATION

This application claims the benefit of priority to U.S. Provisional Application Ser. No. 61/592,456, entitled “Litter Wizard System” filed on Jan. 30, 2012, and currently co-pending.

### FIELD OF THE INVENTION

The present invention generally relates to odor control system for pets. The present invention is more particularly, though not exclusively, related to a system of odor control consisting of absorbent granules and an enzymatic spray for capturing and neutralizing odors caused by pets and their elimination of waste.

### BACKGROUND OF THE INVENTION

There is currently a need for a non-toxic and all natural product that aggressively and efficiently eliminates pet odor caused by pet waste. The source of the odor may be cat litter, a litter box, pet bedding, a dog kennel, and any place where pets eliminate their waste. The cause of the odor is usually naturally occurring ammonia or bacteria in pet waste that emanates an ammonia smell. Additionally, ammonia is the leading cause of respiratory problems in pets.

Cleaning cat urine and other pet waste effectively depends on many factors such as where it is located, how long it has been there, and the type of surface it was deposited on. Currently available products that can reduce pet odors usually come in a one part system. They are typically an additive for cat litter, a cat litter that already has an odor controlling substance pre-mixed into it, or a spray that is applied directly to the source of odor to neutralize the odor-producing materials. Some of these products use cheaper and less desirable materials, including harmful chemicals, which do not tightly bind to or neutralize the odor causing agents. This allows the odor causing agents to be released back into the environment thereby allowing the pet odor to persist.

Several products exist for the control of pet odors. All of them consist of a single product that is used to attack the source of the odor problem, which usually is the result of pet waste. The types of control consist of chemicals, enzyme based products, and absorbents.

Chemicals used to control pet odor are acids, bleaches, peroxide, and other harsh type chemicals. Most, if not all, of these chemicals are harmful if ingested. Most notably, harmful vapors are created when bleach mixes with ammonia and are a major cause of respiratory illness in pets.

Enzyme based products attack the source of the odor such as urine and organic waste. An enzyme based product works by consuming and eliminating residual organics which are the most common source of odor.

Absorbents, such as baking soda and regular cat litter, work by capturing non-volatile organic compounds through absorption. Absorbents also capture volatile organic compounds into the pore structure of the absorbent, through molecular sieving. Another effect of absorbents is the reduction of moisture. The reduction of moisture helps to minimize fly and parasite infestations that can transmit disease to pets and humans. It also minimizes or eliminates the development of molds, bacteria, and fungus which are also major causes of respiratory ailments in a pet.

In light of the above, it would be advantageous to provide a solution for the control and removal of pet odors that is both hygienic and safe. It would also be advantageous to provide a pet odor reducing product that minimizes or eliminates the causes of reduced hygiene for a pet which will be beneficial to the overall health of the pet and the environment that they live in.

It would also be advantageous to provide a pet odor control product that is useful in areas other than a litter box. This invention can be used on pet bedding, the bottom of pet cages such as a bird cage or dog crate, and areas where a pet may be confined such as a dog kennel. The buildup of pet urine over time can create a strong and persistent pet odor that simple rinsing with water cannot remove. This invention would be useful to attack and eliminate these odors in a safe and environmentally manner.

### SUMMARY OF THE INVENTION

The Litter Wizard System of the present invention is a two (2) part system consisting of absorbent granules and an enzyme spray. When used in conjunction with each other, the two (2) parts of the Lifter Wizard System provide a high level of odor and moisture control. The Litter Wizard System can be used with a cat litter box, pet bedding, a dog kennel, or any area where a pet eliminates its waste. The system is useful in homes, animal hospitals and shelters, veterinary clinics, pet shops, kennels, pet groomers, zoos, and anywhere that animals are housed for extended periods of time.

The granules are the true science of the product system, allowing it to deliver superior results. They are a non-toxic and earth friendly product specifically designed to absorb odor causing ammonia. The granules are mixed with naturally occurring ammonia eating microbes that breakdown and remove excess ammonia that the litter and granules cannot absorb. The microbes also penetrate into the pores, cracks, or crevices of a surface, such as concrete, where they will breakdown and remove any trapped ammonia molecules thereby minimizing, or even eliminating all sources of pet odors.

Ammonia and volatile organic compounds are captured into the pore structure of the granules by molecular sieving. Non-volatile organic compounds are absorbed on the large surface area of the Litter Wizard System granules. The granules are layered into regular cat litter or spread in an area used by pets to eliminate their waste. The granules can also be spread onto pet bedding or the floor of a pet cage. Since the granules are non-toxic, its continued use will not harm the pet or the environment.

Moisture contamination in Utter boxes, bedding, and cages or indoor pet urination is responsible for the development of molds, bacteria, and fungus, all of which are major causes of respiratory illness in pets. The Litter Wizard System granules absorb, control, and even eliminate moisture to create an environment conducive to pet health. Adequate moisture control will help control insect and parasite infestations as well as molds, bacteria, and fungus. As the Litter Wizard System granules become saturated, they will disperse the absorbed moisture into the air while retaining any absorbed contaminants and return the powder to its original absorbing property. This ability to disperse moisture renders the Litter Wizard System highly desirable for use in litter boxes, pet cages, and bedding. The Litter Wizard System is also very effective in treating accidental pet urination on carpets and flooring.

The spray consists of a high concentration of the same microbes found in the Litter Wizard System granules. The high concentration of microbes and direct application of the spray results in an aggressive and intense action of digesting ammonia and absorbing other odor causing material. This will result in minimizing or eliminating the odor emanating from the pet area. The spray can also be applied to the fur of a pet to reduce or eliminate odor caused by ammonia or other odor causing agents that become trapped in a pet's fur.

The Litter Wizard System granules and spray have a unique manufacturing process that places the high activity enzymes into a dormant state to guarantee extended shelf life and maximum enzymatic activity when used.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 shows a side cutaway view of a litter box showing the Litter Wizard System applied with standard cat litter;

FIG. 2 shows a top view of a dog kennel showing an area where a dog will consistently expel its waste and the application of the Litter Wizard System to that area; and

FIG. 3 is a flow chart showing the process for preparing a Litter box for use and daily maintenance.

### DETAILED DESCRIPTION OF A PREFERRED EMBODIMENT

The Litter Wizard System was developed to reduce the pungent odor in cat litter boxes and pet cages that is caused by ammonia fumes and moisture which build up from pet urine and waste. The Litter Wizard System is a two (2) part system that consists of a microbe rich spray and absorbent granules that also contain microbes similar to those contained in the spray. The system works cooperatively to control pet odor generated from pet waste through the removal of ammonia and the absorption of moisture and other contaminants associated with pets. The system will capture and hold ammonia, skatole gasses, and mercaptans, all of which have an unpleasant odor. When the Litter Wizard System becomes saturated with ammonia, it will continue to encapsulate and capture ammonia by releasing liquid in the form of water back into the environment. This water can then either be absorbed by the cat litter or dispersed into the air. The use of the Litter Wizard System provides an odor controlling function that is ten times more effective than other cat litter additives and sprays currently on the market. The Litter Wizard System is a 100% non-toxic and organic formula that will not harm pets if ingested and is safe for the environment.

The Litter Wizard System granules consist in part of Clinoptilolite, a naturally occurring form of Zeolite. The Clinoptilolite molecule is shaped like a honey-comb and carries a natural negative charge. The negative charge gives an ion exchange property having a strong exchange affinity for ammonia which usually has a positive charge associated with NH₄⁺. In its natural form, Cliniptilolite contains a wide variety of positively charged ions such as sodium, potassium, and calcium. These positive ions are loosely held and can readily be exchanged for others when in a contact solution. Since Clinoptilolite is a microporous solid and has a very regular pore structure of molecular dimensions, it acts as a molecular sieve. The sieve action allows it to selectively sort molecules based primarily on a size exclusion process. In the present invention, these characteristics allow the granules to capture the ammonia, volatile organic compounds (VOCs), non-VOCs, and other contaminants found in pet waste.

The Utter Wizard System granules also work to control moisture through absorption. As the granules absorb moisture and become saturated, they will return water to the atmosphere and trap any contaminants in the moisture including ammonia. The water that is returned to the atmosphere will either be absorbed by the regular cat litter or be dispersed into the air. Since the contaminants are not released by the granules back into the air, the water that is released will have little to no odor.

The Lifter Wizard System enzyme spray contains a laboratory developed blend of high activity microbes which quickly digest odor causing ammonia. In a preferred embodiment, the enzyme spray of the present invention is aerobic, anaerobic and facultative. They are fermented and non-reproductive plant based microbial enzymes, including but not limited to Aspergillus oryzae, lipidase, protease, and have a specific gravity of approximately 1.0, a boiling point of 212.degrees, and contain no hazardous components as defined in OSHA 20 CFR 1910.1200. The manufacturing process places the high activity microbes in a dormant state to guarantee extended shelf life of the product and maximum enzymatic activity when used. The Utter Wizard System enzyme spray is also highly effective on organic odors and stains from vomit, feces, blood, and sewage.

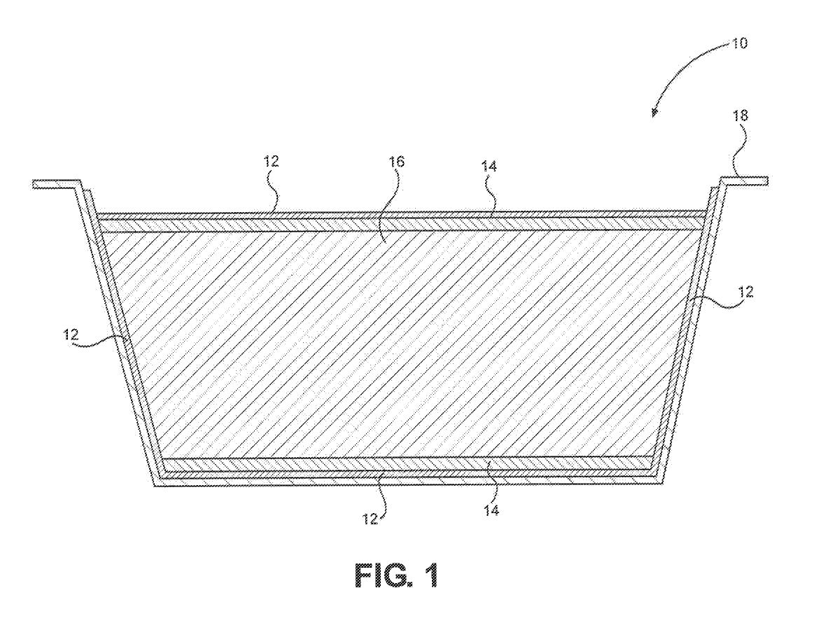

Referring to FIG. 1, the preferred embodiment of the present invention is shown and generally designated 10. In this preferred embodiment, a cat litter box 18 consists of sprayed layer 12 and granules 14 that applied to a cat litter box 18 in conjunction with each other and standard cat litter 16. To effectively use the system, the litter box 18 must first be washed. After the litter box 18 has dried, the inside surface of the Utter box 18 is sprayed with a Litter Wizard System enzyme spray, creating a sprayed layer 12. After the spray layer 12 has dried, approximately ½ cup of the Litter Wizard System granules 14 is evenly spread on the bottom of the litter box 18. It is to be appreciated by someone skilled in the art that other amounts of granules 14 can be used depending on the size of the litter box 18 and the number of pets that will use it. Next, fresh cat litter 16 is evenly spread over the granules 14. After that, granules 14, approximately 2 cups for example, are sprinkled on top of the layer of cat litter 16, and covered by a spray of the enzyme 12. The normal digging habits of a cat when using a litter box 18 will mix the granules 14 throughout the cat litter 16.

After the litter box 18 is prepared for use, it is maintained on a daily basis by scooping out clumped and solid materials, sprinkling granules 14, approximately cup for example, over the top of the litter 16 then applying a layer of enzyme spray 12 to the top of the granules 14. Due to the high concentration of enzymes in the spray, through the sprayed layer 12, most, if not all, of odor-causing sources and bacteria within the litter 16 and litter box 18 will be killed on contact, and the odor will be eliminated.

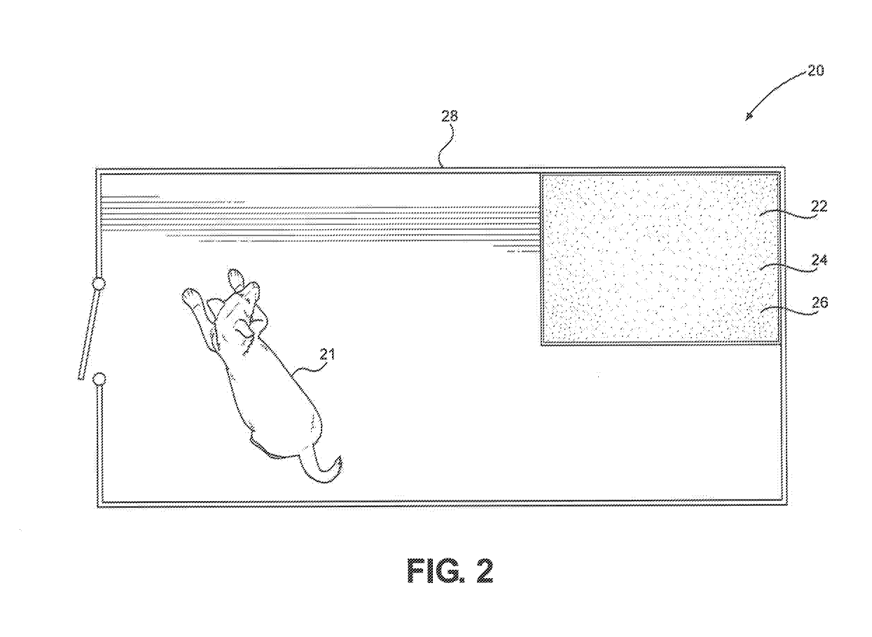

Referring to FIG. 2, an alternative embodiment of the present invention is shown and generally designated 20. In this alternative embodiment, the Litter Wizard System is applied to a dog kennel 28. Since most dogs 21 will return to the same area 22 to expel their waste, that area 22 can specifically be targeted for application of the Lifter Wizard System. To treat these areas, the enzyme spray is applied to the area 22 forming sprayed particles 24, followed by a sprinkling of granules 26 over the same area 22. Since the Litter Wizard System is non-toxic and environmentally friendly, no harm to the dog will result by the presence of the granules 26 or sprayed particles 24. It is to be appreciated by someone skilled in the art that the Litter Wizard System can be used in any area where a dog expels its waste, including, but not limited to concrete materials. The ability of the microbes to penetrate into cracks, crevices, and pores of a surface allows it to penetrate into the surface of concrete and attack any residual sources of odor.

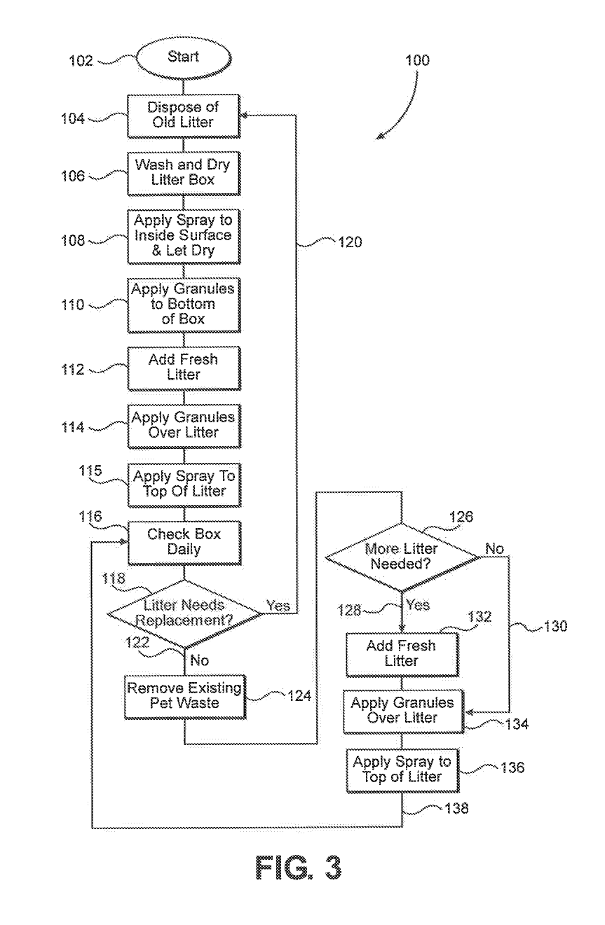

Referring to FIG. 3, a flowchart of methods and steps of preparing a litter box for use as well as daily maintenance, generally referred to as 100, starts at step 102. Step 102 is followed by step 104 to dispose of all of the used litter. Then, the litter box is washed and dried at step 106. Once the litter box is dried, at step 108, the Litter Wizard System enzyme spray is applied to the inside surface of the box and allowed to dry. In the preferred embodiment, a sufficient amount of the Litter Wizard System enzyme spray is applied to create a complete coating on the inside of the litter box. After the layer of spray dries, at step 110, the Litter Wizard System granules are applied to the bottom of the litter box. It is to be appreciated by someone skilled in the art that the amount of granules to apply will vary depending on the size of the litter box and the number of pets that will use it. Multiple pets or a larger litter box will require more of the Litter Wizard System granules to be applied. In the preferred embodiment, a sufficient amount of absorbent granules are applied to create a thin layer that completely covers the bottom of the litter box. Then, the user is directed to step 112 to add fresh standard cat litter over the granules applied at step 110. Next, at step 114, an additional layer of granules is applied over the fresh cat litter applied at step 112. In the preferred embodiment of the present invention, two (2) cups (for example) of granules per pet are applied to the top of the fresh cat litter. However, other amounts depending on the needs of the pet are fully contemplated. A layer of spray is applied in step 115 to the additional layer of granules applied in step 114, and the litter box is then ready for use.

With regard to the daily maintenance of the preferred embodiment of the present invention, the litter box is checked daily at step 116. If the litter is saturated with pet waste and needs replacement at step 118, via path 120, the user is directed to step 104 to repeat the process of preparing a litter box. If the litter within the litter box does not need replacement at step 118, via path 122, the user is directed to step 124 to remove existing pet waste. The existing pet waste may be removed by any means known in the art. If at step 126 it is determined that no additional litter is needed, the method advances along path 130 to step 134. Alternatively, if at step 126, it is determined that more litter is needed, the method proceeds along path 128 to add fresh litter in step 132.

Once fresh litter is added, if needed, granules are applied over the surface of the litter in step 134. In a preferred embodiment, granules, approximately ¼cup for example, are evenly applied over the existing litter. Next, in step 136, several layers of the Litter Wizard System enzyme spray are added to the top of the cat litter and granules. It is to be appreciated by someone skilled in the art that the number of sprays applied in step 136 can be varied based on factors such as the size of the lifter box, the number of pets that use the Utter box, and the amount of odor emanating from the litter box during maintenance. At the end of step 136, the user is directed back to step 116 via path 138 to check the litter box daily, for daily maintenance of the Lifter Wizard System of the present invention.

The Litter Wizard System can also be used in other pet areas to effectively control odor. For instance, pet bedding can be treated with both the spray and granules. The floor of an indoor pet kennel or cage can be treated in a manner similar to a dog kennel by applying the enzyme spray to the floor then sprinkling the granules over the same area.

The Litter Wizard System granules have uses other than odor control. The granules can be used in a garden or flower pots to aerate and drain the soil to obtain better root growth. They can also be used as an absorbent for oil and grease spills, as an anti-slipping agent on snow and ice, or as an aggregate in lightweight concrete.

While there have been shown what are presently considered to be preferred embodiments of the present invention, it will be apparent to those skilled in the art that various changes and modifications can be made herein without departing from the scope and spirit of the invention.

1. A pet odor control system, comprising:
an enzyme spray, said enzyme is a fermented non reproductive plant based microbial agent comprising Aspergillus oryzae and at least one of lipidase and protease; and
absorbent granules comprising clinoptilolite having a negative charge.

2. The pet odor control system of claim 1, wherein said enzyme is aerobic, anaerobic and facultative.

3. (canceled)

4. (canceled)

5. The pet odor control system of claim 1, wherein said enzyme has a boiling point of 212 degrees Fahrenheit.

6. The pet odor control system of claim 1, wherein said absorbent granules comprise a naturally occurring form of Zeolite.

7. (canceled)

8. The pet odor control system of claim 1, wherein said enzyme spray further comprises a high concentration of the microbes found in said granules.

9. The pet odor control system of claim 1, wherein said enzyme spray and said absorbent granules cooperate to more efficiently and effectively control pet odor generated from pet waste through the removal of ammonia and the absorption of moisture.

10. A method of controlling pet odors in a litter box, comprising:
providing a litter box having an inside surface and a bottom;
apply an enzyme spray to the inside surface of the litter box and allowed to dry;
apply granules to the bottom of the litter box;
add fresh cat litter over the granules;
add a layer of granules over the fresh cat litter; and
apply a layer of spray to the layer of granules.

11. The method of controlling pet odors of claim 10, further comprising;
checking the litter box;
remove existing pet waste;
add fresh litter;
apply a layer of granules over the surface of the litter; and
apply a layer of spray enzyme to the layer of granules.
